(19) United States
(12) Patent Application Publication
(10) Pub. No.: US 2014/0067837 A1
(43) Pub. Date: Mar. 6, 2014

(54) IDENTIFYING USER-SPECIFIC SERVICES THAT ARE ASSOCIATED WITH USER-PRESENTED ENTITIES

(71) Applicants: Shajib Sadhuka, Seattle, WA (US); Amit Kumar, Redmond, WA (US)

(72) Inventors: Shajib Sadhuka, Seattle, WA (US); Amit Kumar, Redmond, WA (US)

(73) Assignee: Microsoft Corporation, Redmond, WA (US)

(21) Appl. No.: 13/597,210

(22) Filed: Aug. 28, 2012

(51) Int. Cl. G06F 17/30

(52) U.S. Cl. 707/758; 707/E17.005

(57) ABSTRACT

User-specific services are presented to users together with associated entities. Initially, providers of services provide information about such services, including a name of the service, action that correlates the service to an entity being presented to the user, identification of entities with which the service is correlated, and further information to which the user can be directed. Subsequently, a user can identify those services to which they have a connection, derive the benefits of, or are otherwise associated with. Collections of entities can be reviewed to determine whether any entities are associated with services that the user has identified as having a connection thereto and those entities having such an association can be presented with indicia of such an association. An action is presented to the user, and user action directed thereto provides additional information in the form of a pop-up window, a separately presented collection of information, or both.

### BACKGROUND

Users of computing devices increasingly rely upon search functionality to find items of interest to such users. The utilization of search functionality is particularly common in the context of networked computing devices where the sought for information can be located on any one of a myriad of computing devices. The most easily recognizable example of such reliance on search functionality is the popularity of search websites that offer users the ability to search content available via the ubiquitous Internet and the equally ubiquitous World Wide Web. Search functionality, however, is equally useful in other networked environments, including closed networks, such as would be found in corporate or academic environments.

Typically, the providers of search functionality seek to provide users with identifications of information that is most responsive to the user's search query. Consequently, certain personal information, such as a user's location, can be utilized to provide results that are more useful to the user. For example, a user looking to purchase a specific item can receive search results identifying establishments that sell such an item and that are physically proximate to the user's current location. Such results are likely more useful to such a user then results that identified establishments irrespective of their physical proximity to the user.

But, while the utilization of personal information can provide search results that are tailored to a given user, the presentation of such search results is performed in a pre-defined, unvarying manner, irrespective of which user they are being presented to. In particular, search results are typically presented to users in the form of an identifier of the information found to be responsive, a pointer to such information, such as a location for which such information can be retrieved more fully, and, optionally, some small portion of such responsive information to enable the user to more accurately gauge whether the user desires to obtain the remainder of such responsive information. While the specific information that is found to be responsive can vary depending on a user's personal information, the presentation of such responsive information does not.

### SUMMARY

In one embodiment, a user can identify specific services with which the user is associated, including, for example, a user's memberships, interests, benefits, and the like. Subsequently, search results, or other identifications of entities, can be modified to include cues to the user that such entities are associated with the user-specific services that the user identified.

In another embodiment, aspects of the specific services with which the user is associated can be presented in-line, or within the same interface context, with the entities that are being presented to the user.

In a further embodiment, service providers, such as the providers of memberships, common interest associations, providers of benefits, and the like, can generate information about such services to enable a user to identify those services with which they are associated, and to subsequently enable automated mechanisms to correlate those services with entities that are being presented to the user. The provided information about such services can comprise a service name, and action that can correlate the service to an entity being presented to the user, and identification of entities with which the service is correlated, and a “landing page” to which the user can be directed for further information.

In a still further embodiment, the correlation between entities and user-specific services can be performed as part of the presentation of such entities to a user, or can be performed independently thereof, such as by a third-party whose mechanisms can be referenced by a service provider, or by a search or indexing service whose functionality can be leveraged by the service provider.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system that identifies and presents user-specific services that are associated with entities that are being presented to the user;

FIG. 2 is a mockup diagram of an exemplary user interface presenting entities and associated user-specific services;

FIG. 3 is a flow diagram of an exemplary identification of user-specific services that are associated with entities that are being presented to the user; and

FIG. 4 is a block diagram of an exemplary computing device.

### DETAILED DESCRIPTION

The following description relates to the identification and presentation of user-specific services that are associated with entities that are being presented to the user. The user-presented entities can be in the form of search results, or other presentations of entities, which can include identifications of published works, retail establishments, online presences, and other entities. Initially, providers of services, such as discount associations, functional service providers, other membership organizations, common interest groups and the like, can provide information about such services, including a name of the service, action that can correlate the service to an entity being presented to the user, an identification of entities with which the service is correlated, and further information to which the user can be directed. Subsequently, a user can identify those services to which they have a connection, such as services to which the user has a membership or shares a common interest. Collections of entities can be reviewed to determine whether any entities are associated with services that the user has identified as having a connection thereto and those entities having such an association can be presented with indicia of such an association.

The techniques described herein focus on the presentation of Internet search results via a browser, such as the ubiquitous “web browser.” However, such descriptions are not meant to suggest a limitation of the described techniques to only search results, nor to identifications of web pages or other like collections of network-accessible content, nor to only to the display of such within the context of a web browser. To the contrary, the described techniques are equally applicable to identify and present services associated with one or more entities from among any collection of entities, howsoever assembled, whether through searching or otherwise, and whether comprising identifications of collections of data that are network-accessible or otherwise. Similarly, the described techniques are equally applicable to the presentation of such associated services in any user interface context or application.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

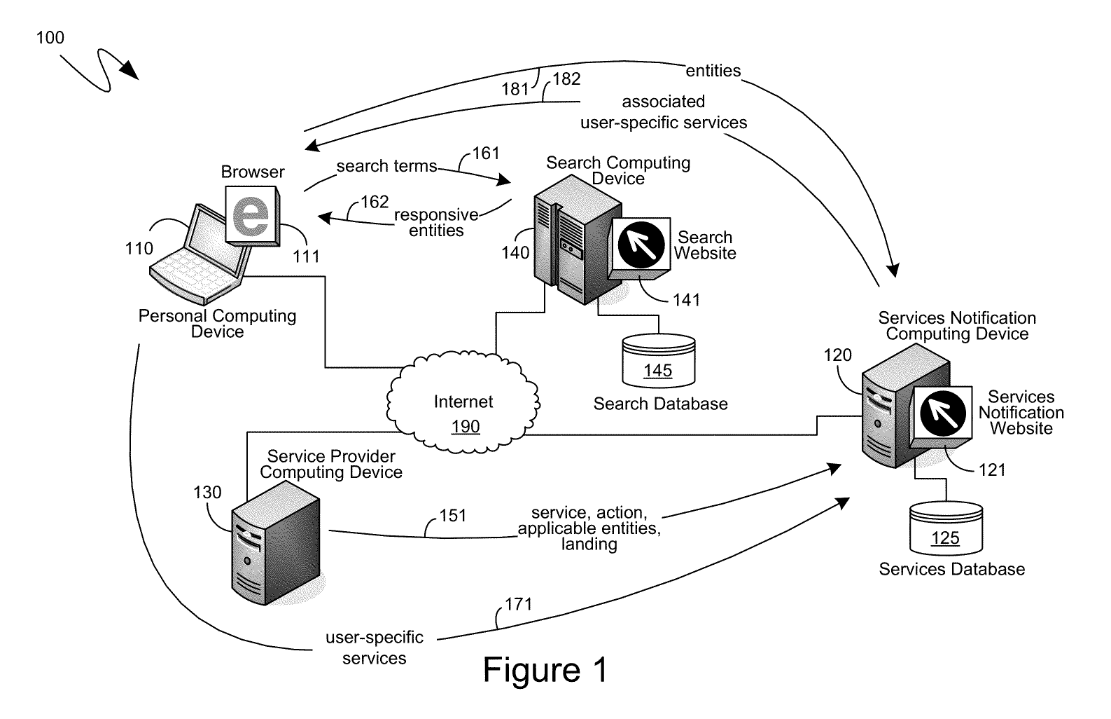

With reference to FIG. 1, an exemplary system 100 is illustrated, comprising a personal computing device 110, a search computing device 140, a services notification computing device 120 and a service provider computing device 130, all of which are shown as being communicationally coupled to one another via the Internet 190. As indicated previously, although the descriptions herein will be provided within the general context of the Internet and the World Wide Web, such context is provided only to ease the presentation of the concepts described herein and, as such, references to the Internet, the World Wide Web, webpages, web links, and the like are strictly exemplary and are not intended to limit the mechanisms described to Internet protocols, such as the Transmission Control Protocol (TCP), the Internet Protocol (IP), the HyperText Transfer Protocol (HTTP) or any other Internet-specific technology. As illustrated in the system 100 of FIG. 1, the personal computing device 110 can be executing a browser 111 that can display, to a user of the personal computing device 110, information retrieved over the Internet 190. In one embodiment, the browser 111 can be utilized to search for information on the Internet 190, such as by transmitting search terms 161 to a search computing device 140 which can be hosting a search website 141. In a manner well known to those skilled in the art, the search computing device 140 can utilize a search database 145 to identify responsive entities 162 that are responsive to the search terms 161.

Typically, the responsive entities 162 will be provided in the form of identifications of collections of network-accessible data, such as webpages, that comprise one or more of the search terms 161, or are otherwise deemed to be relevant, by the search computing device 140, to the search terms 161. More specifically, the search website 141 can generate a webpage, which can be accessible by the browser 111, and which can comprise the responsive entities 162, such that the browser 111 can then display them to the user of the computing device 110. Typically, such a webpage comprises not only an identification of the responsive entities 162, such as in the form of a web link, but also comprises information about the responsive entities 162 to enable the user to determine whether or not to obtain additional information from the responsive entities 162. For example, in addition to a web link, a title of the identified webpage, and a small portion of the content of such a webpage are also often provided as part of the identification of the responsive entities 162.

In many instances, the “entity” that is presented to the user is not the webpage itself, but rather the thing embodied by the webpage. For example, a user searching for a movie can be presented with an identification of a webpage at which the user can purchase the movie for viewing. In such an instance, as conceptualized by the user, the responsive “entity” is not the webpage itself, but rather the movie that is embodied by the webpage. The webpage only serves, in the user's mind, as a conduit through which the user can view the movie through the identified webpage. Consequently, as utilized herein, the term “entity” means an item or collection of items as conceptualized by the user. Examples of “entities” that can be presented to the user in the form of web links include audio/visual content, such as books or movies, retail objects, such as electronic devices, retail establishments, such as stores or restaurants, and online presences, such as Web services.

In one embodiment, one set of information that can be provided to a user along with the responsive entities 162 can be an identification of one or more services that such a user may have access to which can be associated with one or more of the responsive entities 162. For example, returning to the above example of a user searching for a movie to watch, the user of the personal computing device 110 may also be a cable television subscriber such that the cable television service to which the user subscribes provides the user with access to certain movies on-demand at no charge, and is part of that user's cable television subscription package. In such an example, the user's cable television subscription package, which provides access to these on-demand movies, can be a “service” that the user can have. Thus, in one embodiment, in addition to providing the user with an identification of a website through which the user can purchase and watch the movie that the user searched for, the user can also be provided with a notification that the searched-for movie can be viewed at no charge as part of the user's on-demand service.

As utilized herein, the term “service” means any advantage or information that is provided to a select, defined group of individuals as part of those individuals' membership, interest, association, or other like grouping. Examples of “services” that a user can be a part of include discount services, such as corporate discounts or group discounts, loyalty programs, such as frequent flyer programs or credit card loyalty programs, functional memberships, such as audio/video purchasing or consumption memberships, and common-interest services, such as charities and professional associations.

As illustrated in the system 100 of FIG. 1, the service provider computing device 130 can be any computing device that can be utilized by a service provider to provide the information 151 to the services notification computing device 120. In particular, to provide users with the ability to indicate that they have access to a particular service, and to provide the services notification computing device 120 with the ability to associate services with particular entities, a service provider can utilize a service provider computing device 130 to provide information 151 to the services notification computing device 120. The provided information 151 can, in one embodiment, include an identification of the service, an action correlating such a service with an entity, an identification of one or more associated entities, or entities to which such services are applicable, and a “landing page” or other collection of data that can provide greater information about the service in connection with one or more entities. The provided name can be utilized to enable a user to recognize the service, such as will be described in detail below, and, as such, can be the name by which such a service is commonly known or marketed. The action correlating the service with an entity can be based on the function or benefit provided by the service vis-à-vis an entity. For example, returning again to the above example of an on-demand video provision service, the action that such a service can provide, vis-à-vis an entity like a movie, can be a “watch” action. As another example, a service that provides users with unlimited access to audio content based upon, for example, the payment of the monthly fee can specify a “listen” action. As yet another example, a loyalty service that provides users with frequent purchaser points or frequent filer miles can specify an “earn points” or “earn miles” action, thereby indicating that users can somehow earn miles with an associated entity. Similarly, a service that provides users with a, for example, corporate discount, can specify a “get discount” action.

In one embodiment, the action that identifies the correlation between the service and an associated entity can be one of a predefined set of actions, such as the above provided examples. In such an embodiment, a service provider could select from among one or more of the predefined actions to define how their service correlates with associated entities. As will be recognized by those skilled in the art, such an embodiment can avoid user confusion that could arise when different service providers utilized differing terminology for conceptually similar actions. In another embodiment, however, the action that identifies the correlation between the service and an associated entity can be defined by the service provider and need not be limited to a predefined set of actions, thereby enabling new types of services to be dynamically added without limitation.

In addition to providing a service name and an action correlating such a service to one or more associated entities, other aspects of the information 151 provided to the services notification computing device 120 by a service provider can include an identification of the entities to which a service is associated. For example, returning to the above example of an on-demand video provision surface, the entities with which such services are associated can be the movies that are currently available for on-demand viewing. In one embodiment, such entities can be identified through a simple listing such as, for example, a listing of the movies that are currently available for on-demand viewing. In another embodiment, such entities can be identified by referencing a dynamically updated list that can be maintained by the service provider, such as at the service provider computing device 130.

Another aspect of the information 151 that can be provided to the services notification computing device 120 can be an identification of a collection of data such as a “landing page” to which a user can be directed should they desire additional information regarding the service's association with a corresponding entity. In some instances, the landing page may be no different than the webpage identifying the entity in the first place. For example, a webpage directed to the purchase of airline tickets at a specific airline can be considered a representation of an entity through which a user belonging to that airline's frequent flyer club could earn frequent flyer miles. Consequently, while an “earn miles” action may correlate such an entity to the frequent flyer membership service, the webpage to which the user would be directed for additional information about how to earn miles can be the same webpage as the webpage directed to the purchase of airline tickets at that specific airline since the same webpage can comprise both information regarding the purchase of airline tickets and information regarding how such a purchase, or subsequent flying, can earn miles through their frequent flyer membership service. In other instances, however, the landing page can be different than the webpage, or other collection of data, that identifies an entity. Returning to the above example of an on-demand video viewing service, an entity, in the form of a movie available through such an on-demand video viewing service, can be identified by a webpage that merely provides generic information about such a movie such as, for example, the year in which the movie was made, the principal actors in the movie, a plot synopsis, and other like information. Such a webpage would not necessarily enable a user to view such a movie, but rather is a commonly referenced resource that, as such, can be considered to be a conceptual representation of the movie entity. Instead, for the user to view such a movie through the on-demand video viewing service, the user would need to be directed to a different webpage, or other collection of data. In such an example, the entity can be identified with a pointer to one webpage, namely the webpage providing generic information about a movie, while the “watch” action that can correlate such an entity to a specific service can direct the user to another, different, webpage, namely the webpage through which the user could access the on-demand video viewing service to watch such a movie.

While the above description was provided within the context of webpages, the collection of data to which a user can be directed, should the user desire further information about the service, can be an application, including mobile applications, stand-alone applications, and script-based applications. For example, a user utilizing a mobile computing device, such as a cellular telephone computing device, may have an application that was provided by a service provider and provides additional information about the service, or enables the user to access the service. In such an example, the service provider can specify the application as the collection of information to which the user is to be directed. For example, if the service is an on-demand video service, such a service may only be accessible through dedicated video view application programs. In such an example, should an entity be a movie that the user can view via the on-demand video service to which the user subscribes, and which is, therefore, a user-specific service, the notification of such a user-specific service that can be presented together with such an entity can direct the user to the dedicated application and can, in one example, cause such a dedicated application to commence viewing of that particular movie.

In one embodiment, rather than requiring a service provider to specifically enumerate all of the entities to which the service provided by such a service provider is relevant, a search or indexing service can be leveraged to collect the relevant information. In particular, a search engine that has indexed various collections of data may already have collected the relevant information needed to identify entities that are associated with a specific service. For example, websites for specific restaurants can include webpages comprising information regarding the various dining discount services with which such restaurants participate. Thus, if a service provider were to identify such a dining discount service, the index built by the search engine can already comprise information that indicates that specific entities, namely the restaurants whose websites comprise indicia of their participation in such programs, are associated with such a dining discount service. In such a manner, rather than providing an explicit or indirect specification of related entities, a service provider, in one embodiment, need not provide anything further than an identification of the service to enable the services notification computing device 120 to identify those entities that are associated with the service.

As will be recognized by those skilled in the art, such a utilization of the data collected by a search engine can require semantical indexing of such data. For example, there may exist many different ways within which an entity, such as a retail establishment, can express their association with specific services, including, for example, utilizing differing terminology, utilizing differing data structures, such as pup-ups or banners, and the like. Thus, in one embodiment, the data collected by a search engine can be semantically indexed to enable an automated determination of which entities are associated with which services.

The information provided by various service providers, such as the information 151, can be retained by the service's notification computing device 120 in a services database 125. In one embodiment, the services notification computing device 120 can host a services notification website 121 through which a user, such as the user of the personal computing device 110 can utilize the browser 111 to identify one or more of the services stored in the services database 125 as being user-specific services to which the user has access, is a member of, can obtain the benefits of, or is otherwise associated with. With such information, services notification computing device 120 can then identify, to the user, entities having associated user-specific services, such as when the user is presented with a listing of entities.

For example, returning to the specific example illustrated in the system 100 of FIG. 1, the user of the personal computing device 110 can utilize the browser 111 to access the search website 141 hosted by the search computing device 140. In response to the search terms 161 provided by the user, the search website 141 can return a listing of responsive entities 162. As indicated previously, such responsive entities 162 are typically provided in the form of identifications of webpages comprising information deemed to be relevant to the search terms 161. In one embodiment, such a listing of responsive entities 162 can be provided to the services notification computing device 120 via the communication 181. In response, the services notification computing device 120 can identify whether any of the services, which the user of the personal computing device 110 had identified as user-specific services, are associated with any one of the more of the entities received via the communication 181, and can return such associated user-specific services to the browser 111 via the communication 182. The browser 111 can, thereby, display not only the responsive entities 162, but can also notify the user of any associated user-specific services.

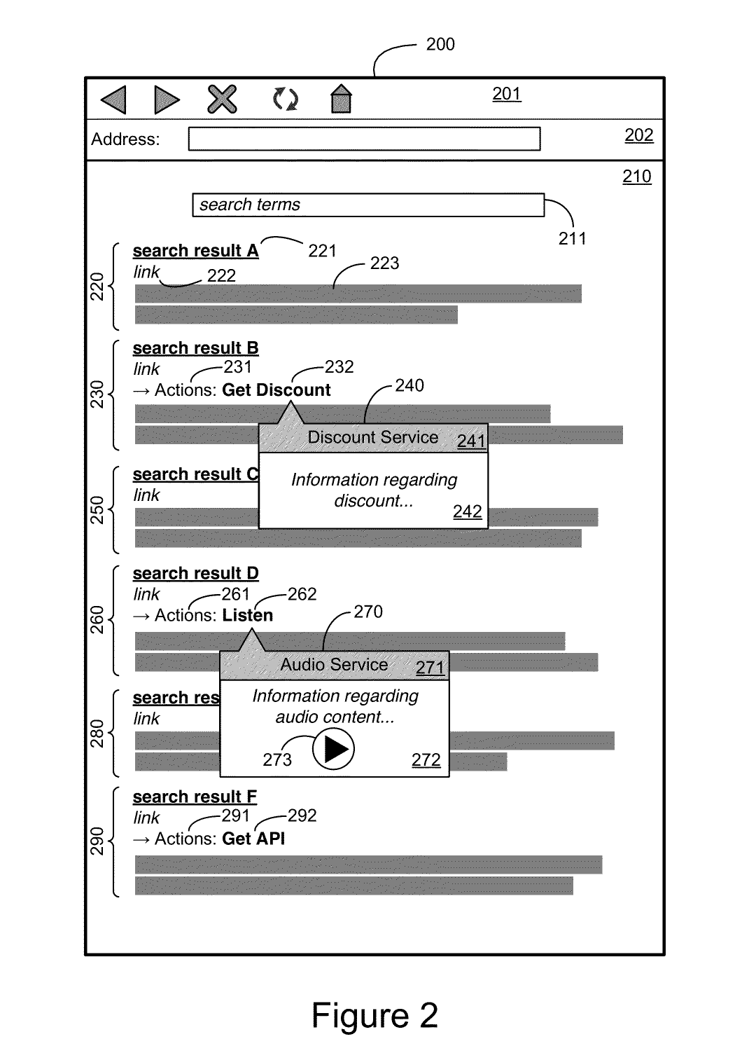

In one embodiment, such as that illustrated by the exemplary system 100 of FIG. 1, the services notification computing device 120 can be distinct from the search computing device 140, such as by being maintained by an entity that is independent of the entity providing the search website 141. In such an embodiment, the search website 141, in order to avail itself of the information provided by the services notification computing device 120, can, when generating a webpage with the responsive entities 162, also include, within such a webpage, instructions to cause the browser 111 to provide responsive entities 162 to the services notification computing device 120 and, received therefrom, the associated user-specific services 182. For example, the webpage comprising the listing of responsive entities 162 can include the invocation of a script that can be hosted by the services notification computing device 120. The browser 111 can invoke such a script, as instructed by the webpage that was generated by the search website 141, and which comprises the responsive entities 162. Once invoked, the script can collect the responsive entities 162 and provide them to the services notification computing device 120, as illustrated by the communication 181. Additionally, in such an embodiment, the webpage generated by the search website 141 can have reserved space within which to display the associated user specific services 182 that may be returned by the services notification computing device 120. An exemplary user interface is illustrated in FIG. 2 and described in further detail below.

In another embodiment, the services notification computing device 120 and the search computing device 140 can be maintained by the same entity and, indeed, can be part of the same computing device. In such an embodiment, the communications 181 and 182 need not be between the browser 111, executing on an independent personal computing device 110, and the services notification computing device 120, but rather can be between the search computing device 140 and the services notification computing device 120, which, as indicated, can be co-executed, such that the provision of the responsive entities 162 by the search computing device 140 to the user can comprise both the responsive entities 162 and the associated user-specific services 182. In a variation of such an embodiment, information from the services notification computing device 120, such as the associated user specific services 182, can be utilized by the search computing device 140 in re-ranking the responsive entities 162, or otherwise modifying the responsive entities 162 that are provided to the user.

Additionally, although the exemplary embodiment illustrated in the system 100 of FIG. 1 is within the context of Internet search functionality, the mechanisms described herein are not so limited. Instead, the actions can also be generated for the presentation of entities in other contexts including, for example, social media contexts, homepage contexts, mobile data contexts and the like.

Turning to FIG. 2, an exemplary user interface 200 is shown illustrating one method by which a user can be notified of user-specific services that are associated with entities that are being presented to the user. Again, for purposes of description and illustration, the exemplary user interface 200 is shown within the context of an Internet search although, as indicated previously, the mechanisms and presentations described are not so limited. The exemplary user interface 200 of FIG. 2 is shown as comprising a toolbar 201 that can be presented by the application presenting the exemplary user interface 200, as well as an address bar 202 that can also be presented by such an application, and which can provide information identifying the collection of data that is being displayed. In the particular exemplary interface 200 of FIG. 2 a webpage 210 is shown having an input mechanism 211 by which a user can enter search terms. The webpage 210 can further comprise search results 220, 230, 250, 260, 280 and 290.

As will be recognized by those skilled in the art, search results typically comprise a title or other identifier of the collection of data that was deemed to be responsive to the user search, and identification of that collection of data, such as a link to the identified webpage, and a selected portion of, typically textual, data to provide context for the user, often referred to as a “snippet”. Thus, in the exemplary user interface 200 of FIG. 2, the search result 220 can comprise a title 221 of the webpage, or other collection of data, that is identified by that search result, a link 222, or other pointer to that collection of data, and snippet 223 that can provide the user with additional context such as, for example, an excerpt of textual data from the webpage having the link 222 that can illustrate how such a webpage is responsive to the user's search terms.

As indicated previously, at least some of the search results 220, 230, 250, 260, 280 and 290 can be conceptualized as “entities” including, for example, search results that identify movies, songs, specific merchandise available for purchase, a specific retail establishment, such as a shop or a restaurant, a specific provider of goods or services, such as an airline, or a rental car company, and other like entities. Some of the entities identified by one or more of the search results 220, 230, 250, 260, 280 and 290 can be associated with services that the user receiving the search results can be a member of, receive the benefits of, or otherwise be associated with. Consequently, in one embodiment, such a user can be notified of any services, specific to that user, that are associated with the relevant ones of the entities identified by the search results. For example, search result 230 can identify an entity, such as a retail establishment, that can offer discounts to specific individuals such as, for example, employees of a particular corporation, or members of a particular dining or purchasing club. If the user receiving the search results is an employee at such a corporation, or is a member of such a dining club, then the user can be notified, together with the search result 230, of such a service. For example, the search result 230, in addition to having elements analogous to those identified above with reference to search result 220, can also comprise an actions indicator 231 that can list a “get discount” action 232.

In one embodiment, the “get discount” action 232 can act as a trigger for a pop-up window 240, or other like user interface element, that can display further information when the user performs an action on the “get discount” action 232 such as, for example, by hovering a cursor on the “get discount” action 232. The pop-up window 240 can comprise additional information about the service that is associated with the entity identified by the search result 230 and correlated therewith by the “get discount” action 232. For example, the pop-up window 240 can comprise an identification area 241 that can identify the specific service associated with the entity identified by the search result 230, such as, for example, the corporate discount service, or the dining club, through which the user can obtain a discount at the retail establishment identified by the search result 230. The pop up window 240 can also comprise an additional information area 242 that can provide additional information such as, for example, the amount of the discount that the retail establishment identified by the search result 230, in the present example, offers to members of the corporate discount service, dining or purchasing club, or other like service.

As another example, the search result 260 can, for example, identify an entity associated with audio. For example, the search result 260 can identify a song, or a book of which an audio book version exists. Additionally, the user to whom the search results are being presented can be a member of a service through which such audio can be consumed by the user such as, for example, an online audio streaming service that can be supported by monthly dues, a frequent reader club through which a user can receive audio books, or other like services. In such an example, among actions 261 that can be listed with the search result 260 can be a “listen” 262 action. Such a “listen” action 262 can enable the user to hear the audio entity that was identified by the search result 260 utilizing a service that the user has already signed up for, is a member of, or otherwise receives the benefits of. Consequently, the pop-up window 270 that can be triggered by user action on the “listen” action 262 can comprise identification area 271 in which such a service can be identified, information area 272 where the user can be provided with additional information and, optionally, a mechanism, or control, 273 by which the audio content can be consumed by the user “inline” and without needing to manually visit another online location, such as another webpage.

In addition to the above enumerated examples, services which can be associated with entities can include services that provide the user with access to information that is of interest to the user. For example, common interest services can be directed to obtaining particular information or aspects of information such as, for example, application program interfaces that can be exposed by developers of other webpages. Thus, for example, as illustrated by the search result 290, an associated action 291 can include a “get API” action 292 that can enable the user to obtain an application program interface that can be exposed by the developer of the webpage identified by the search result 290. Other common interest services can, likewise, be directed to the obtaining of information from entities that is relevant to those interests.

In some circumstances, the webpage identified by, for example, search results can be similar, or equivalent, to that which can be pointed to by one or more associated actions. For example, returning to the above example of the search result 230 being a webpage of a retail establishment entity, such a webpage can itself comprise information regarding a discount service such as, for example, by including a statement indicating that the retail establishment offers a discount to employees of specific corporations. In such an example, the webpage identified by the search result 230 can be the same webpage to which user is directed if the user selects the “get discount” action 232. In one embodiment, the user can select the “get discount” action 232 by clicking on it, or otherwise directing a similar user interface action to it, while merely hovering, or otherwise directing a similar user interface action, to the “get discount” action 232 can result in the presentation of the pop-up window 240.

Modifying the above example slightly, the webpage identified by the search result 230 may not necessarily comprise any information regarding an associated discount service. Consequently, selecting the search result 230 can direct the user to a webpage that provides no further information regarding an association between the entity represented by the webpage and one or more user-specific services. Instead, in such a modified example, additional information regarding, for example, an associated discount service can be part of a different webpage, which can be maintained by the service, by the retail establishment identified by the search result 230, or otherwise. In such an instance, selection of the “get discount” action 232 can direct the user to such another webpage where the retail entity identified with the search result 230 can be identified, but now with additional information indicating the availability of, for example, a discount for employees of a specific corporation. As yet another example, such information may not be a wholly separate webpage, but rather can be a banner, or other like user interface element, that can only be presented by the webpage identified by the search result 230 when such a page is notified that the user is a member of a particular service, such as an employee of a specific corporation.

As indicated previously, there may also exist circumstances where the webpage identified by the search result can differ from the webpage, or other collection of information, to which the user can be directed when selecting an associated user-specific service. For example, the search result 260 can direct the user to a webpage through which the user can purchase a particular book, such as through a well-known online book retailer. Such a webpage, however, may not be related to a service through which the user can obtain the audio of the audiobook version of such a book. Indeed, the online book retailer may not even provide such a service. Instead, as indicated previously, the search result 260, although it identifies a specific webpage of a specific online book retailer, can be conceptualized by a user as an identification of a particular entity such as, in the present example, the book that can be purchased via the webpage identified. Consequently, the user-specific service providing the user with an audiobook version can be related to the entity represented by the search result 260, as opposed to being related to the specific webpage identified by the search result 260. Additionally, the audio content, in the present example, such as that which can be played by the user inline by the control 273, can be provided from one or more server computing devices associated with the user-specific service, as opposed to from the website of the online book retailer.

Although not specifically illustrated in the exemplary user interface 200 of FIG. 2, one entity may be associated with multiple user-specific services. For example, the entity identified by the search result 230 can be associated with, for example, two different user-specific services, both of which provide the user with discounts at the associated entity. In such an instance, in one embodiment, a single “get discount” action 232 can still be presented, except that, when triggered, the pop-up window 240 can provide information about both of the user-specific services. Thus, for example, two different identification areas 241 and two different additional information areas 242 can be presented within the single pop-up window 240. In one embodiment, the ordering of such services, as presented in, for example, the pop-up window 240, can be based on a variety of factors including, for example, which service provides a greater discount, which service has a greater number of users that have indicated that they are associated with it, which service has the user previously selected within similar contexts, or similar entities, and other like factors.

As another example, a single entity may be associated with multiple-user specific services that differ in the advantages they provide to the user. For example, search result 260 which, returning to the prior example, can identify book as sold by a particular online retailer, can also have associated with it a user-specific service that offers the user a discount at that online retailer. In such an example, the actions 261, which are listed as part of the search result 260, can include the “listen” action 262, as illustrated, but can also include a “get discount” action, such as the “get discount” action 232, which can be listed together with the “listen” action 262, such as to the left or right of the “listen” action 262.

The exemplary user interface 200 is only one mechanism by which a user can be presented with user-specific services that are associated with user-presented entities. In another embodiment, rather than presenting indicia of associated user-specific services through actions enumerated proximate to the presentation of the entities, the associated user-specific services can be listed independently, separate and apart from the presentation of the entities. For example, the associated user-specific services can be presented in their own view or webpage. Alternatively, the user can be presented with the option to trigger their presentation in one of a variety of mechanisms, thereby selecting the user interface that is most easily consumed by that particular user.

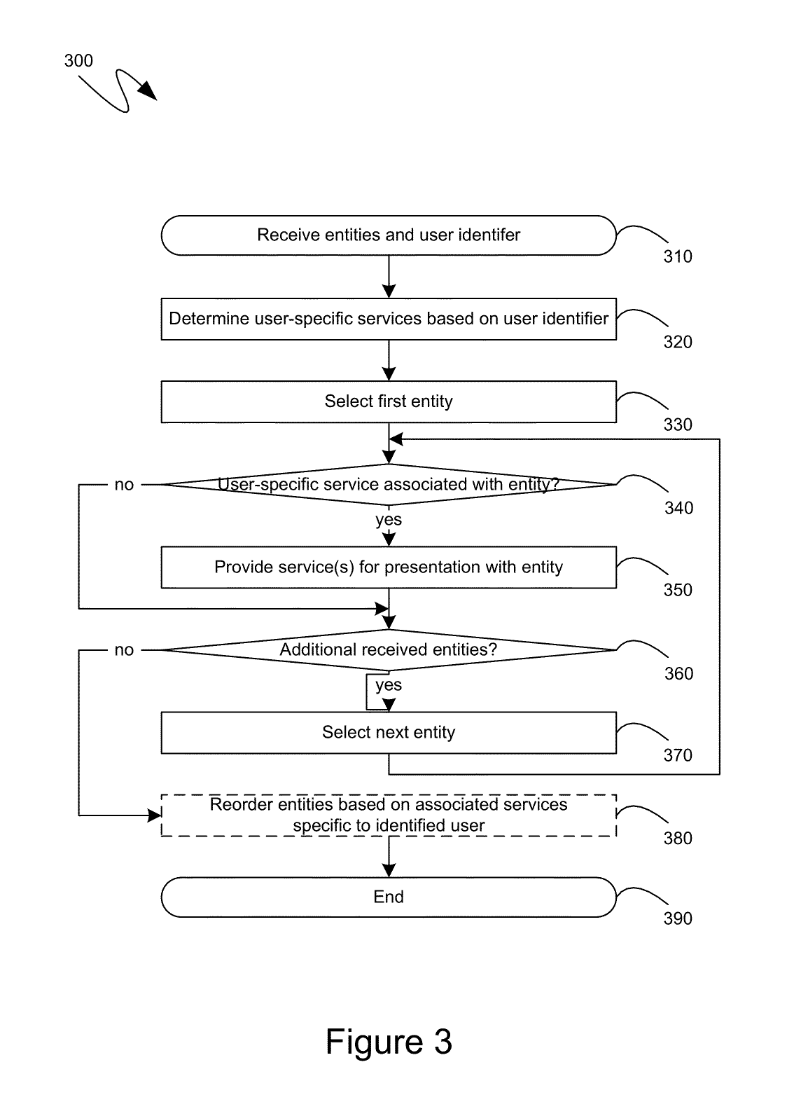

Turning to FIG. 3, flow diagram 300 shown therein illustrates an exemplary series of steps by which user-specific services can be associated with one or more entities from among a collection of entities. Initially, at step 310, the listing of entities can be obtained, as well as an identification of a specific user that has previously selected and indicated one or more services of which the user is a member, can derive the benefits of, or is otherwise associated with. As indicated previously, in one embodiment, users can be provided with a mechanism, such as a website, through which various services can be identified to the users and the users can indicate which of those services they are a member of, derive the benefits of, or otherwise associated with. The presentation of such services can be based on the information received from service providers, such as that described in detail above. Subsequently, when a user identifies themselves, their previously selected user-specific services can be determined and can be compared to obtained entities, such as those obtained at step 310. In particular, at step 320, the previously selected user-specific services can be determined based on the identification of the user that was received at step 310.

Subsequently, at step 330, an initial entity from among the entities received at step 310 can be selected and a determination can be made, at step 340, whether the user has identified a service that is associated with that entity. As also indicated previously, a service provider can identify entities with which such a service is associated including, for example, a static listing of such entities or a dynamically updated listing, such as can be maintained by the service provider. In yet another embodiment, the service provider can identify a category of entities with which such a service would be associated. For example, the service provider can indicate that it offers on-demand viewing of all movies that have been released within the last six months. Consequently, in such an example, at step 340, in determining whether any user-specific service is associated with the selected entity, an initial determination can be made as to what are the movies have been released within the last six months. In making such determination, reference can be made to “authoritative” sources, such as well-regarded or highly trafficked information stores sourcing information of an appropriate category. In one embodiment, a service provider, in identifying a category of entities, can identify one or more such authoritative sources that the service provider desires to be utilized in determining which entities are associated with the service provided by the service provider. In another embodiment, such authoritative sources can be determined dynamically by the entity-service correlation mechanisms.

Once the entities associated with the service are determined, whether by reference to a static or dynamic listing thereof, or by reference to authoritative sources of identified categories of services, a subsequent determination, at step 340, can be to determine whether any of the entities associated with the service are equivalent to the entity that was selected, such as at step 330. If, at step 340, is determined that no user-specific services are associated with the selected entity, processing can proceed to step 350. Conversely, if, at step 340, it is determined that at least one user-specific service is associated with the selected entity, then processing can proceed to step 350.

In one embodiment, at step 350, an identification of one or more services, along with the relevant user interface information, can be provided for presentation with the associated entity. For example, information comprising an identified action, as well as information to be presented within a pop-up window, can be provided such that such actions can be presented to the user along with the entity, such as in the manner illustrated in FIG. 2 and described in detail above. In another embodiment, as part of step 350, a determination can first be made as to whether the user should be notified of an associated service. More specifically, there may exist the possibility of the “user fatigue” should the user receive too many notifications of associated services. For example, a user searching for a particular book is likely to receive a series of search results, each of which identifies a different web page, from differing book retailers, listing the same book, namely the book that the user searched for. In such an example, the user may not find it helpful to have a “listen” action presented along with every single search result. Instead, in one embodiment, as part of step 350, a determination can be made as to whether the entity currently being processed has already been previously processed and found to have a user-specific service associated with it. If the entity was previously processed, as part of the same group of entities that was received at step 310, then a determination can be made whether to provide information regarding the associated service again. Alternatively, a determination can be made whether to provide information regarding the associated service with the current entity being processed as opposed to with the prior entity. For example, it may be more desirable for a user to have the “listen” action presented with a search result identifying a particular book from a well-known online book retailer, as opposed to being presented with the search result identifying the same book, except from a less well-known book retailing source. The well-known online book retailer can, thereby, act as an “authoritative” source for specific types of entities such as, for example, books. In such an embodiment, in a situation where the entities received at step 310 comprise multiple versions of the same entity, such as multiple webpages that identify the same book, except is being offered for sale by different online look retailers, the provision of associated user-specific services to be presented along with the entity, at step 350, can occur only for entities as identified by authoritative sources. Thus, as utilized herein, the term “authoritative source” means either a source that is either identified by a service provider as a reference by which to determine whether a service provided by the service provider is associated with an entity, or a source that is at least as well known as any other source providing similar information, resources or functionality. Additionally, to distinguish from the embodiment described previously, where a service provider can maintain a dynamically updated listing of entities to which the service provided by the service provider is associated, the term “authoritative source”, as utilized herein, means a source other than the service provider itself, and which is independent of the service provider.

Turning back to the exemplary flow diagram 300 of FIG. 3, once one or more user-specific services associated with an entity are provided for presentation with that entity, at step 350, or, alternatively, if, at step 340, it was determined that there are no user-specific service associated with the entity, processing can proceed to step 360 at which point a determination can be made as to whether there are additional entities to be processed from among the entities that were received at step 310. If such additional entities exist, then processing can proceed to step 370, where the next entity can be selected. Processing can then loop back to perform steps 340 and 350, such as described in detail above. If, however, at step 360, is determined that there are no additional received entities to be processed, the relevant processing can end at step 390.

In one embodiment, as indicated above, the mechanisms for notifying a user of user-specific services associated with one or more of the entities being presented to the user can be part of the same mechanism that is presenting the entities to the user, or can be integrated therewith. In such an embodiment, as an optional step, processing can proceed to step 380, prior to ending at step 390, and can determine whether the presentation of entities to the user should be reordered based on identified user-specific services that were associated with those entities. For example, entities having user-specific services associated with them can be presented ahead of entities that do not have user-specific services associated with them. Step 380 is illustrated in the flow diagram 300 of FIG. 3 with dashed lines to indicate that it is an optional step.

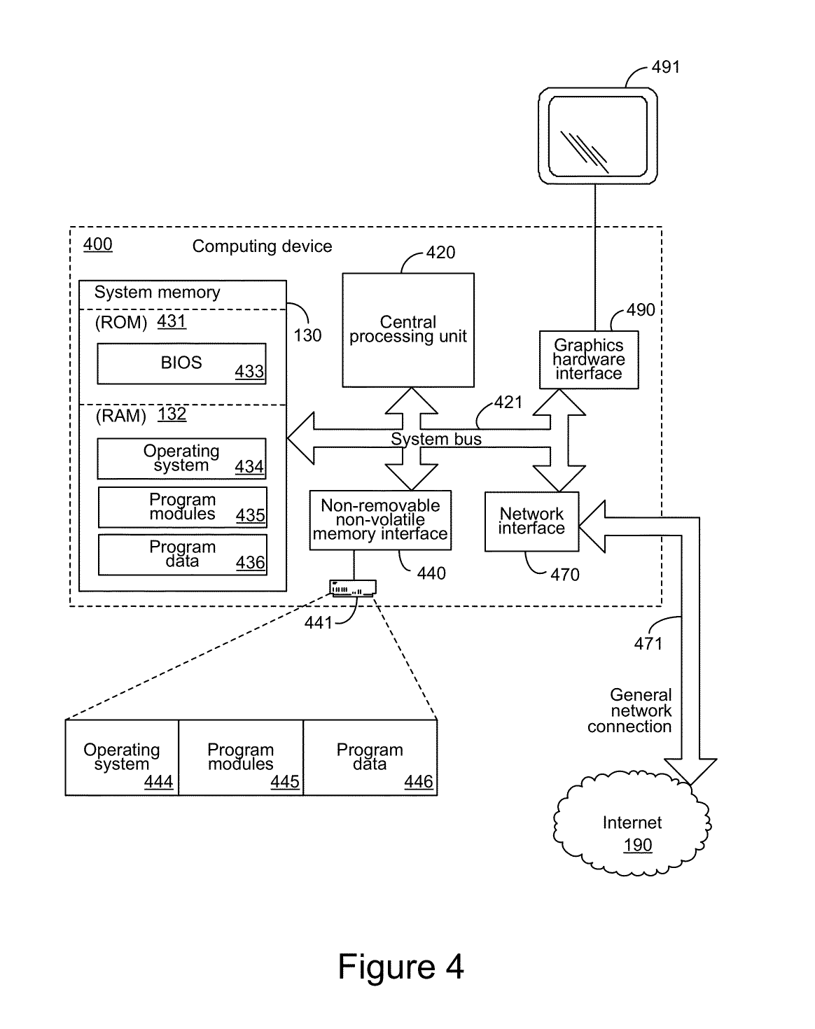

Turning to FIG. 4, an exemplary computing device 400 is illustrated which can perform some or all of the mechanisms and actions described above, and which can be any one of the computing devices described above, including, without limitation, the personal computing device 110, the services notification computing device 120, the search computing device 140 or the service provider computing device 130. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include the Peripheral Component Interconnect (PCI) bus and various higher speed versions thereof, the Industry Standard Architecture (ISA) bus and Enhanced ISA (EISA) bus, the Micro Channel Architecture (MCA) bus, and the Video Electronics Standards Associate (VESA) bus. The computing device 400 can optionally include graphics hardware, including, but not limited to, a graphics hardware interface 490 and a display device 491.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 2 illustrates operating system 434, other program modules 435, and program data 436.

The computing device 400 may also include other removable/non-removable, volatile/nonvolatile computer storage media. By way of example only, FIG. 2 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440.

The drives and their associated computer storage media discussed above and illustrated in FIG. 2, provide storage of computer readable instructions, data structures, program modules and other data for the computing device 400. In FIG. 2, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

Of relevance to the descriptions below, the computing device 400 may operate in a networked environment using logical connections to one or more remote computers. For simplicity of illustration, and in conformance with the exemplary system 99 of FIG. 4, the computing device 400 is shown in FIG. 2 to be connected to the Internet 90. However, the computing device 400 is not limited to any particular network or networking protocols. The logical connection depicted in FIG. 2 is a general network connection 471 that can be a local area network (LAN), a wide area network (WAN) or other networks. The computing device 400 is connected to the general network connection 471 through a network interface or adapter 470 which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 471. It will be appreciated that the network connections shown are exemplary and other means of establishing a communications link between computing devices may be used.

As can be seen from the above descriptions, user-specific services that are associated with entities being presented to a user can also be presented to the user to enable the user to more effectively utilize such services. In view of the many possible variations of the subject matter described herein, we claim as our invention all such embodiments as may come within the scope of the following claims and equivalents thereto.

We claim:

1. One or more computer-readable media comprising computer-executable instructions for correlating user-specific services to user-presented entities, the computer-executable instructions directed to steps comprising:
obtaining at least some of the user-presented entities;
obtaining an identification of a user to whom the user-presented entities are presented;
determining the user-specific services based on the identification of the user, the user-specific services being those services that the identified user has previously selected as being associated with the identified user;
selecting one of the obtained user-presented entities;
comparing the selected entity to user-specific service entities, the user-specific service entities being those entities that have been identified as associated with at least one of the user-specific services;
determining, based on the comparing, user-specific services associated with the selected entity, the user-specific services associated with the selected entity being those user-specific services that are associated with user-specific service entities that are equivalent to the selected entity; and
providing, for presentation with the selected entity, the determined user-specific services associated with the selected entity.

2. The computer-readable media of claim 1, wherein the computer-executable instructions for obtaining the at least some of the user-presented entities comprise computer-executable instructions for obtaining identifications of webpages that represent the least some of the user-presented entities.

3. The computer-readable media of claim 1, comprising further computer-executable instructions for determining at least some of the user-specific service entities by reference to a semantically indexed search database comprising data collected from at least one of the user-specific service entities or the user-specific services.

4. The computer-readable media of claim 1, comprising further computer-executable instructions for determining at least some of the user-specific service entities by reference to at least one authoritative source that is independent of service providers providing the user-specific services.

5. The computer-readable media of claim 1, wherein the computer-executable instructions for providing the determined user-specific services that are associated with the selected entity comprise computer-executable instructions for providing an action by which the determined user-specific services are associated with the selected entity.

6. The computer-readable media of claim 5, wherein the action is at least one of a “get discount” action, an “earn points” action, an “earn miles” action, a “listen” action, a “watch” action or a “get API” action.

7. The computer-readable media of claim 1, wherein the computer-executable instructions for providing the determined user-specific services that are associated with the selected entity comprise computer-executable instructions for providing a landing webpage that differs from a user-presented webpage representing the selected entity.

8. The computer-readable media of claim 1, wherein the computer-executable instructions for providing the determined user-specific services that are associated with the selected entity comprise computer-executable instructions for providing, for at least one of the determined user-specific services, information to enable utilization of the at least one of the determined user-specific services in an inline manner.

9. The computer-readable media of claim 1, wherein the computer-executable instructions for providing the determined user-specific services that are associated with the selected entity only provide the determined user-specific services if the selected entity is represented by an authoritative source.

10. The computer-readable media of claim 1, wherein the user-specific services comprise at least one of a discount service, a loyalty service or an audio/video service.

11. One or more computer-readable media comprising computer-executable instructions for correlating user-specific services to user-presented entities, the computer-executable instructions directed to steps comprising:
receiving, from a service provider, an identification of a service provided by the service provider;
receiving, from the service provider, an identification of one or more entities with which the service is associated;
receiving, from the service provider, an identification of an action through which the service is associated with the identified one or more entities; and
presenting, to a user, a listing of services from among which the user can select user-specific services about which the user will be notified if an entity that is being presented to the user is associated with one of the user-specific services selected by the user;
wherein the association between the user-presented entity and the user-specific service is based on the identification of the one or more entities received from the service provider.

12. The computer-readable media of claim 11, wherein the computer-executable instructions for receiving the identification of the one or more entities with which the service is associated comprise computer-executable instructions for utilizing the identification of the service in connection with a semantically indexed search database, comprising data collected from at least one of the service provider or the one or more entities, to identify the one or more entities with which the service is associated.

13. The computer-readable media of claim 11, wherein the computer-executable instructions for receiving the identification of the one or more entities with which the service is associated comprise computer-executable instructions for referencing an authoritative source that is independent of the service provider.

14. The computer-readable media of claim 13, wherein the authoritative source is selected based on a category of entities to which the service, provided by the service provider, is directed.

15. The computer-readable media of claim 11, wherein the received identification of the action is at least one of a “get discount” action, an “earn points” action, an “earn miles” action, a “listen” action, a “watch” action or a “get API” action.

16. An user interface, displayed on display device, for providing a user with a notification of user-specific services that are associated with user-presented entities, the user interface comprising:
one or more identifiers of collections of information, each collection of information representing one of the user-presented entities; and
at least one action displayed proximate to at least one of the identifiers, the at least one action representing a correlation between the user-presented entity proximate to whose identifier the at least one action is displayed and a user-specific service that provides the displayed action and which is associated with the user-presented entity proximate to whose identifier the at least one action is displayed.

17. The user interface of claim 16 further comprising a pop-up window associated with the at least one action, the pop-up window comprising an identification of the user-specific service and additional information regarding the action as provided by the user-specific service.

18. The user interface of claim 17, wherein the pop-up window further comprises an audio presentation or a video presentation.

19. The user interface of claim 17, wherein the pop-up window further comprises an identification of a second user-specific service, which differs from the user-specific service but is also correlated, through the same at least one action, with the user-presented entity proximate to whose identifier the at least one action is displayed, and additional information regarding the action as provided by the second user-specific service.

20. The user interface of claim 16, wherein the collections of information are webpages and the one or more identifiers of the collections of information comprise: a title of a web page, a link to the webpage, and a snippet from the webpage.
